(19) United States
(12) Patent Application Publication
(10) Pub. No.: US 2013/0251507 A1
(43) Pub. Date: Sep. 26, 2013

(54) EPDM COMPOSITION

(71) Applicants: Takuya Yamanaka, Tokyo (JP); Masahiro Suzuki, Aichi (JP); Takayuki Kato, Aichi (JP); Takahiro Hoshida, Aichi (JP); Masato Takamatsu, Aichi (JP); Shuichi Yasuda, Aichi (JP)

(72) Inventors: Takuya Yamanaka, Tokyo (JP); Masahiro Suzuki, Aichi (JP); Takayuki Kato, Aichi (JP); Takahiro Hoshida, Aichi (JP); Masato Takamatsu, Aichi (JP); Shuichi Yasuda, Aichi (JP)

(73) Assignee: KABUSHIKI KAISHA TOYOTA JIDOSHOKKI, Aichi (JP)

(21) Appl. No.: 13/991,259

(22) PCT Filed: Nov. 29, 2011
(86) PCT No.: PCT/JP2011/077528

§ 371 Date: Jun. 3, 2013

(30) Foreign Application Priority Data
Dec. 7, 2010 (JP) 2010-272147

(51) Int. Cl. C09K 3/10; F04B 15/00

(52) U.S. Cl. CPC C09K 3/1006; F04B 15/00
USPC 415/110; 524/574; 524/572

(57) ABSTRACT

Disclosed is an EPDM composition for molding sealing materials, containing a plasticizer; the plasticizer being a paraffinic oil or naphthenic oil in which the absolute value of the difference between its SP value (solubility parameter; determined by Small's formula) and the SP value of EPDM is 0.3 (cal/cm³)^{1/2} or less; and the composition being free of an ether ester plasticizer. The EPDM composition for molding sealing materials has the following excellent effects. Because a paraffinic oil or naphthenic oil that is compatible with EPDM and has an absolute value of the difference between its SP value and the SP value of EPDM of 0.3 (cal/cm³)^{1/2} or less is used as the plasticizer, a peroxide crosslinked product of the EPDM composition does not form defects that cause the starting point of blisters even when it is subjected to extraction by being brought into contact with HFO-1234yf. Accordingly, the peroxide crosslinked product, when used as a sealing material, particularly a compressor sealing material, exhibits excellent blister resistance to a hydrofluoroolefin refrigerant, such as HFO-1234yf.

### TECHNICAL FIELD

The present invention relates to an EPDM composition. More particularly, the present invention relates to an EPDM composition that can suitably be used as a molding material for sealing materials having excellent HFO-1234yf resistance.

### BACKGROUND ART

HFC-134a (1,1,1,2-tetrafluoroethane) is used as a refrigerant in industrial and household freezers and refrigerators, household air-conditioners, car air-conditioners, etc. However, HFC-134a has a global warming potential (GWP) as high as 1,300; therefore, the replacement of HFC-134a by refrigerants with a low GWP is promoted. Recently, HFO-1234yf (2,3,3,3-tetrafluoro-1-propene), which is a hydrofluoroolefin with a GWP of 4 and an ozone layer depletion potential (ODP) of 0, shows great promise as a new refrigerant, and its practical use has been under consideration. HFO-1234yf has reached the final stage of commercialization as an alternative refrigerant for car air-conditioners as a result of the joint development of DuPont and Honeywell. The cooling capability and energy efficiency of HFO-1234yf only differ by 5% or less from those of HFC-134a.

For HFC-134a, which has been conventionally used as a refrigerant, an ethylene-propylene-diene copolymer type rubber (EPDM) or a hydrogenated nitrile rubber (HNBR) is used as a molding material for sealing materials (see Patent Document 1). Of these, EPDM has a high resistance to HFC-134a, but has inferior blister resistance in the environment of HFO-1234yf, which has been developed as a new refrigerant, as compared to the environment of HFC-134a. Nevertheless, EPDM ensures sealing properties during low-temperature vibration and has a cost advantage. For this reason, there is a demand for EPDM compositions as seal molding materials that can be sufficiently used in the HFO-1234yf environment.

### PRIOR ART DOCUMENT

### Patent Document

Patent Document 1: WO 2006/137420
Patent Document 2: JP-A-2007-92987
Patent Document 3: WO 2008/078650

### OUTLINE OF THE INVENTION

### Problem to be Solved by the Invention

An object of the present invention is to provide an EPDM composition that can form a sealing material sufficiently usable in the HFO-1234yf environment.

### Means for Solving the Problem

The above object of the present invention can be achieved by an EPDM composition for molding sealing materials, containing a plasticizer; the plasticizer being a paraffinic oil or naphthenic oil in which the absolute value of the difference between its SP value (solubility parameter; determined by Small's formula) and the SP value of EPDM is 0.3 (cal/cm³)^{1/2} or less; and the composition being free of an ether ester plasticizer.

### Effect of the Invention

The EPDM composition for molding sealing materials according to the present invention has the following excellent effects. Because a paraffinic oil or naphthenic oil that is compatible with EPDM and has an absolute value of the difference between its SP value and the SP value of EPDM of 0.3 (cal/cm³)^{1/2} or less, preferably 0.2 (cal/cm³)^{1/2} or less, is used as the plasticizer, a vulcanizate of the EPDM composition does not form defects that cause the starting point of blisters even when it is subjected to extraction by being brought into contact with HFO-1234yf. Accordingly, the vulcanizate, when used as a sealing material, particularly a compressor sealing material, exhibits excellent blister resistance to HFO-1234yf.

### EMBODIMENTS FOR CARRYING OUT THE INVENTION

As EPDM, any products obtained by copolymerization of ethylene and propylene with a small amount of various non-conjugated diene components can be used. Preferably, a product obtained by copolymerization with 5-ethylidene-2-norbornene, dicyclopentadiene, 1,4-hexadiene, or the like is used. The SP value thereof varies depending on the degree of polymerization, the type of diene, the amount of copolymerization, and other conditions; however, it is generally about 7.9 (cal/cm³)^{1/2}. Practically, commercial products, such as EPT3045 (produced by Mitsui Chemicals, Inc.) and EP33 (produced by JSR Corporation), can be used as they are.

The SP value (solubility parameter) as used herein is explained in Patent Document 3 with reference to Polymer Handbook IV (pp. 341-368; published by Interscience Publishers) and Solvent Handbook (pp. 91-93 (1993); published by Kodansha Scientific Ltd.). This value can be determined by Small's method. According to Small's method, the SP value δ can be determined by the formula:

δ=ρ·ΣF/M
ΣF: total of all F values of atoms and groups in molecules or repeating units, proviso that F value is a molar-attraction constant (unit: (cal/cm³)^{1/2}/mol, 25° C.)
M: molecular weight, or molecular weight of repeating units
ρ: molecular density

Examples of the plasticizer used to improve the processability of EPDM include plasticizers, other than ether ester plasticizers, in which the absolute value of the difference between the SP value of the plasticizer and the SP value of EPDM is 0.3 (cal/cm³)^{1/2} or less, preferably 0.2 (cal/cm³)^{1/2} or less; preferably paraffinic oils or naphthenic oils. For example, a paraffinic oil having an SP value of 7.9 (cal/cm³)^{1/2}, or a naphthenic oil having an SP value of 8.1 (cal/cm³)^{1/2}, can be used. The use of a paraffinic oil or naphthenic oil in which the absolute value of the difference between its SP value and the SP value of EPDM is greater than this range as the plasticizer results in poor compatibility with EPDM. A vulcanizate thereof is likely to form defects because of extraction by being brought into contact with HFO-1234yf. Such the starting point of defects facilitate the formation of blisters. The SP value as used herein is a solubility parameter, and the present invention employs data determined by Small's formula.

As the paraffinic oil, which is a petroleum fraction product, commercial products that are generally used and satisfy the specified absolute value difference of the SP values can be used as they are. Examples thereof include Diana Process Oil PW-32, PW-150, and PW-380 (produced by Idemitsu Kosan Co., Ltd.); Super Oil M-10, M-12, M-22, M-32, M-46, M-68, M-100, M-150, and M-460 (produced by Shin-nippon Oil Corporation); Sunpar 107, 110, 115, 150, 2100, and 2280 (produced by Japan Sun Oil Co., Ltd.); and the like. Moreover, as the naphthenic oil, which is also a petroleum fraction product, commercial products that are generally used and satisfy the specified absolute value difference of the SP values can be used as they are. Examples thereof include Diana Process Oil NR-26, NR-68, and NM-280 (produced by Idemitsu Kosan Co., Ltd.); Sunthene 410, 415, 450, 480, 4130, 4240, and 250J (produced by Japan Sun Oil Co., Ltd.); and the like.

Although the technical field is different from that of the present invention, Patent Document 2 discloses a belt transmission device in which the friction transmission surface of a V-ribbed belt is composed of a rubber composition comprising 100 parts by weight of ethylene-α-olefin (-diene) copolymer elastomer, 10 to 25 parts by weight of ether ester plasticizer, and 60 to 110 parts by weight of inorganic filler.

The solubility index of the ether ester plasticizer used in this composition is about 8.3 to 10.7 (cal/cm³)^{1/2}, which is greater than the solubility index of the ethylene-α-olefin (-diene) copolymer elastomer (about 8.0 (cal/cm³)^{1/2}). In addition to such an ether ester plasticizer, the combined use of a paraffinic or naphthenic petroleum-based plasticizer having a solubility index of 6.0 to 8.1 (cal/cm³)^{1/2}, which is almost equal to or less than the solubility index of the ethylene-α-olefin (-diene) copolymer elastomer, has the following effects:

(a) The water leakage properties of the friction transmission surface are improved

(b) When pouring water, the tightly adhesion of the belt to the pulley is enhanced to improve silence performance

(c) Moderate bleeding properties are provided, and sound generation during running can be suppressed by the action of the plasticizer as a lubricant

(d) The formation of cracks on the friction transmission surface can be prevented so that the durability of the belt is increased

However, when an ether ester plasticizer is used as the plasticizer, blister resistance to hydrofluoroolefin refrigerants is not sufficient, as shown in Comparative

Example 3, described later. Furthermore, the Example of Patent Document 2 uses a paraffinic oil having a solubility index of 7.5 (cal/cm³)^{1/2}, in addition to an ether ester plasticizer. Even when such a paraffinic oil is used alone, blister resistance to hydrofluoroolefin refrigerants is not sufficient either, as shown in Comparative Example 1, described later.

The amount of paraffinic oil or naphthenic oil in which the absolute value of the difference between its SP value and the SP value of EPDM is 0.3 (cal/cm³)^{1/2} or less, which is used as the plasticizer, is 5 to 40 parts by weight, preferably 5 to 25 parts by weight, based on 100 parts by weight of EPDM. When the amount of paraffinic oil or naphthenic oil added is less than this range, the desired plasticizing effect cannot be obtained. In contrast, when the amount is greater than this range, foaming occurs.

In addition to the above essential components, the EPDM composition may contain, if necessary, various reinforcing agents or fillers, such as carbon black and white carbon; oxides or hydroxides of divalent metals, such as zinc oxide and magnesium oxide; acid acceptors, such as hydrotalcite compounds; antioxidants; and other compounding agents generally used in the rubber industry.

The EPDM composition comprising the above components is peroxide-crosslinked using an organic peroxide that is generally used in an amount of 0.2 to 8 parts by weight based on 100 parts by weight of EPDM. As the organic peroxide, those that can generally be used for crosslinking of EPDM can be used without limitation. Examples of such organic peroxides include tert-butyl peroxide, dicumyl peroxide, tert-butylcumyl peroxide, 1,1-di(tert-butylperoxy)-3,3,5-trimethylcyclohexane, 2,5-dimethyl-2,5-di(tert-butylperoxy)hexane, 2,5-dimethyl-2,5-di(tert-butylperoxy)hexyne-3, and the like. Furthermore, for the organic peroxide crosslinking, the combined use of a crosslinking aid comprising a polyfunctional unsaturated compound, typified by triallyl isocyanurate, is preferred.

The preparation of the composition is performed by kneading the above components using a kneader (e.g., intermix, kneader, or Banbury mixer) or an open roll. The kneaded product is subjected to vulcanization molding using an injection-molding machine, compression-molding machine, vulcanizing press, or the like, by heating generally at about 150 to 200° C. for about 2 to 60 minutes. The resultant is further, if necessary, subjected to oven vulcanization (secondary vulcanization) at about 100 to 200° C. for about 1 to 24 hours.

The resulting vulcanizate is suitably used as a sealing material (e.g., a compressor sealing material) used for being in contact with a hydrofluoroolefin refrigerant (e.g., HFO-1234yf).

### EXAMPLES

The following describes the present invention with reference to Examples.

### Example 1

| | | |
|---|---|---|
| EPDM (EPT3045, produced by Mitsui | 100 | parts by weight |
| Chemicals, Inc.; SP value: 7.9) | | |
| SRF carbon black (average particle | 60 | parts by weight |
| size: 70 nm) | | |
| Paraffinic plasticizer (Sunpar 110, produced by | 20 | parts by weight |
| Japan Sun Oil Co., Ltd.; SP value: 7.9) | | |
| Antioxidant (Antage RD, produced by | 1 | part by weight |
| Kawaguchi Chemical Industry Co., Ltd.) | | |
| Dicumyl peroxide | 4 | parts by weight |

The above components were kneaded with a kneader and an open roll. The kneaded product was subjected to press vulcanization in a vulcanizing press at 170° C. for 15 minutes, and O-ring of size G25 (internal diameter: 22.4 mm, and wire diameter: 3.1 mm) was obtained.

### Example 2

In Example 1, the same amount of a naphthenic plasticizer (Sunthene 410, produced by Japan Sun Oil Co., Ltd.; SP value: 8.1) was used as the plasticizer.

### Comparative Example 1

In Example 1, the same amount of a paraffinic plasticizer (Diana Process Oil PW-90, produced by Idemitsu Kosan Co., Ltd.; SP value: 7.5) was used as the plasticizer.

### Comparative Example 2

In Example 1, the same amount of a naphthenic plasticizer (Sunthene 430, produced by Japan Sun Oil Co., Ltd.; SP value: 7.0) was used as the plasticizer.

### Comparative Example 3

In Example 1, the same amount of an ether ester plasticizer (ADK Cizer RS700, produced by Adeka Corporation; SP value: 8.9) was used as the plasticizer.

### Comparative Example 4

In Example 1, the same amount of di-2-ethylhexyl phthalate (Taoka Chemical Co., Ltd.; SP value: 9.0) was used as the plasticizer.

### Comparative Example 5

In Example 1, the same amount of an aliphatic polyester plasticizer (Polycizer P-202, produced by DIC Corporation; SP value: 9.0) was used as the plasticizer.

A blister test was conducted on the G25 O-rings obtained in the above Examples and Comparative Examples.

Blister test: The O ring and a liquefied refrigerant (HFO-1234yf) were enclosed in a pressure vessel, and the O ring was immersed in the liquefied refrigerant at 40° C. for 24 hours. After releasing the air, the O ring was taken out and air-heated in a 150° C. thermostatic chamber for 1 hour. Thereafter, the O ring was cut, and the presence of blisters in the cross-section was visually observed.

The results confirmed that in Examples 1 and 2, in which a paraffinic oil or naphthenic oil having an absolute value of the difference between its SP value and the SP value of EPDM of 0.2 (cal/cm³)^{1/2} or less was added as the plasticizer, and no ether ester plasticizer was added, blister formation was not observed, indicating superior blister resistance; whereas in Comparative Examples 1 to 5, in which an ether ester plasticizer, or a paraffinic plasticizer or naphthenic plasticizer having an absolute value of the difference between its SP value and the SP value of EPDM of greater than 0.3 (cal/cm³)^{1/2} was added, blister formation was observed, indicating inferior blister resistance.

1. An EPDM composition for molding sealing materials, containing a plasticizer;
the plasticizer being a paraffinic oil or naphthenic oil in which the absolute value of the difference between its SP value (solubility parameter; determined by Small's formula) and the SP value of EPDM is 0.3 (cal/cm³)^{1/2} or less; and
the composition being free of an ether ester plasticizer.

2. The EPDM composition for molding sealing materials according to claim 1, wherein the paraffinic oil or naphthenic oil has an absolute value of the difference between the SP values of 0.2 (cal/cm³)^{1/2} or less.

3. The EPDM composition according to claim 1, wherein the plasticizer is used in an amount of 5 to 40 parts by weight based on 100 parts by weight of EPDM.

4. The EPDM composition according to claim 1, wherein the plasticizer is used in an amount of 5 to 25 parts by weight based on 100 parts by weight of EPDM.

5. A sealing material formed by peroxide-crosslinking of the EPDM composition according to claim 1.

6. The sealing material according to claim 5, which is used for being In contact with a hydrofluoroolefin refrigerant.

7. The sealing material according to claim 6, which is used in an HFO-1234yf environment.

8. The sealing material according to claim 6, which is used in a compressor to be in contact with a hydrofluoroolefin refrigerant.

9. A compressor to be in contact with a hydrofluoroolefin refrigerant, into which the sealing material according to claim 8 is assembled.

10. The EPDM composition according to claim 2, wherein the plasticizer is used in an amount of 5 to 40 parts by weight based on 100 parts by weight of EPDM.

11. The EPDM composition according to claim 2, wherein the plasticizer is used in an amount of 5 to 25 parts by weight based on 100 parts by weight of EPDM.

12. A sealing material formed by peroxide-crosslinking of the EPDM composition according to claim 2.

13. The sealing material according to claim 12, which is used for being In contact with a hydrofluoroolefin refrigerant.

14. The sealing material according to claim 13, which is used in an HFO-1234yf environment.

15. The sealing material according to claim 13, which is used in a compressor to be in contact with a hydrofluoroolefin refrigerant.

16. A compressor to be in contact with a hydrofluoroolefin refrigerant, into which the sealing material according to claim 15 is assembled.
